(19) United States
(12) Patent Application Publication
(10) Pub. No.: US 2012/0000858 A1
(43) Pub. Date: Jan. 5, 2012

(54) Filter Life Pulsating Indicator and Water Filter System and Method

(76) Inventors: Andy Butler, Palo Alto, CA (US); Jackie Lai, Sunnyvale, CA (US); Todd Pope, Napa, CA (US); Anurupa Rao, Sunnyvale, CA (US)

(21) Appl. No.: 13/098,157

(22) Filed: Apr. 29, 2011

Related U.S. Application Data
(60) Provisional application No. 61/329,413, filed on Apr. 29, 2010.
(60) Provisional application No. 61/371,601, filed on Aug. 6, 2010.

(51) Int. Cl. B01D 35/143; C02F 1/00; B01D 35/14; B01D 35/04

(52) U.S. Cl. 210/741; 210/739; 210/87; 210/89; 210/90; 210/85

(57) ABSTRACT

A computer based method for generating a pulsating water flow through a faucet in response to a filter status, comprising the steps of: determining a water flow rate through a first filter; determining a duration of water flow at said water flow rate; determining the filtered volume of water filtered by said first filter based upon said water flow rate and duration of water flow; determining the filter status by comparing said filtered volume of water and an expected rated service life value of said first filter; and causing the faucet to expel pulsating water when the faucet is in the on state, when the filter status represents that remaining filter life is below a first threshold.

### RELATED APPLICATIONS

This application claims priority from U.S. provisional application No. 61/329,413 filed on Apr. 29, 2010 and U.S. Provisional application No. 61/371,601 filed on Aug. 6, 2010 which are incorporated by reference herein in their entirety.

### FIELD OF THE INVENTION

The invention relates to the field of water filters and more particularly life indicators for water filters.

### BACKGROUND OF THE INVENTION

When a water filter needs to be changed conventional systems may use, for example, one or two light emitting diodes (LEDs), or other lights, to indicate to the user that the filter element should be changed. The LEDs may also blink to indicate when the filter element should be changed. These LEDs which are used to indicate that a filter or other water treatment system element has reached its capacity for contaminant reduction/removal can be out of the line of sight of a user, difficult to understand and, in some cases, can be ignored by the end user they need to communicate to. If a user does not see and/or understand the underlying purpose of the LED indicator and/or does not respond by replacing the filter or other water treatment system element at the prescribed time, ultimately, the filter or other water treatment system element could be used beyond its rated service life and/or capacity, which would allow sub-standard water to reach the end user.

### SUMMARY OF THE INVENTION

A computer based method for generating a pulsating water flow through a faucet in response to a filter status, comprising the steps of: determining a water flow rate through a first filter; determining a duration of water flow at said water flow rate; determining the filtered volume of water filtered by said first filter based upon said water flow rate and duration of water flow; determining the filter status by comparing said filtered volume of water and an expected rated service life value of said first filter; and causing the faucet to expel pulsating water when the faucet is in the on state, when the filter status represents that remaining filter life is below a first threshold. In addition the pulsating water has been filtered by said first filter. Additional steps can include determining the water pressure drop across the water filter; determining the filter status further comprises comparing said water pressure drop with an expected water pressure drop across said first filter; and causing the faucet to expel pulsating water when said filter status represents that the pressure drop across the first filter exceeds said expected water pressure drop by a second threshold value.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a figure of the environment in which the invention operates in accordance with an embodiment of the present invention.

FIG. 2 is flowchart of the operation of one embodiment of the present invention.

FIG. 3 is more detailed description of a water filter assembly in accordance with one embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

A preferred embodiment of the present invention is now described. Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine, microprocessor, microcontroller), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

This invention is a method and system for consumer as well as commercial, point of use (POU) and point of entry (POE) water filter and/or treatment systems that are intended to improve the quality of tap water and/or drinking water and typically have replaceable filter elements or other system elements such as UV bulbs, or consumables that are rated for a given service life or need periodic attention. These ratings or service life times can be governed by recognized, national standards (for example: ANSI/NSF) and in some cases international standards for these types of products. Some service life time, replacement time or consumable replenishment times are established by the original equipment manufacturer. This invention also applies to other residential and commercial water treatment systems that can have elements with a rated service life or required supplies and/or consumables that may need periodic replenishment. Generally speaking, a filter element or other system elements that are part of these systems will have a rating for a specific type of contaminant or multiple types of contaminants that the replaceable filter element is capable of reducing/removing according a recognized standard. This rating is expressed in the number of gallons (volume capacity) that can be treated with a given filter element or other system elements. It is envisioned that the present system invention and methods can be used for other liquids/gases in addition to, or instead of water.

A water filter or treatment system may use, for example, one or two light emitting diodes (LEDs), or other lights, to indicate to the user when the filter element should be changed. The LEDs may also blink to indicate when the filter element should be changed. These LEDs which are used to indicate that a filter or other water treatment system element has reached its capacity for contaminant reduction/removal can be out of the line of sight of a user, difficult to understand and, in some cases, can be ignored by the end user they need to communicate to. If a user does not see and/or understand the underlying purpose of the LED indicator and/or does not respond by replacing the filter or other water treatment system element at the prescribed time, ultimately, the filter or other water treatment system element could be used beyond its rated service life and/or capacity, which would allow sub-standard water to reach the end user.

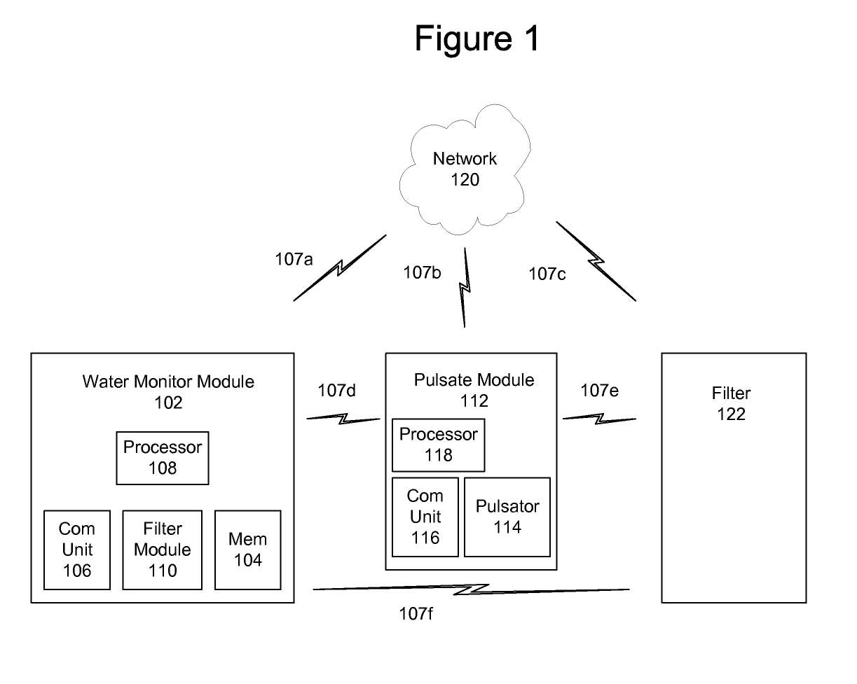

FIG. 1 is a figure of the environment in which the invention operates in accordance with an embodiment of the present invention. The operating environment can includes a water monitor module 102, a pulsate module 112 and a water filter 122. The water monitor module 102 can include a processor 108 a communications unit 106, a filter module 110 and a memory 104. The pulsate module 112 can include a processor 118 a communication unit 116 and a pulsator 114.

In some embodiments communication between the water monitor module 102, pulsate module 112 and filter 122 can be accomplished using communication links 107. The communication links described herein can directly or indirectly connect these devices. The network 120 can be, for example, a wireline or a wireless communication network such as a WiFi, other wireless local area network (WLAN), a cellular network comprised of multiple base stations, controllers, and a core network that typically includes multiple switching entities and gateways. Other examples of the network 120 include the Internet, a public-switched telephone network (PSTN), a packet-switching network, a frame-relay network, a fiber-optic network, combinations thereof, and/or other types/combinations of networks. In other embodiments, some or all of the communication links 107 can be a direct connection between the module, i.e., without using network 120. The communication units 106/116 provide the connections between the water monitor module 102, pulsate module 112 and filter 122 and each other and/or the network 120.

Processors 108 and/or 118 process data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included. The processors can comprise an arithmetic logic unit, a microprocessor, a general purpose computer, or some other information appliance equipped to transmit, receive and process electronic data signals from the memory 104, 114 and other devices both shown and not shown in the figures.

The memory modules 104 and/or 114 can be volatile and/or non-volatile memory, e.g., the memory may be a storage device such as a non-transitory computer-readable storage medium such as a hard drive, compact disk read-only memory (CD-ROM), DVD, or a solid-state memory device. The memory 124 can be physically part of the water monitor module 102 and/or the pulsate module 112 or can be remote from them, e.g., communicatively coupled to the water monitor module 102 and/or the pulsate module 112 via a wired/wireless connection, via a local area network (LAN), via a wide area network (WAN), via the Network 120, directly connected, etc. For ease of discussion the memory 102/112 is described herein as being part of the water monitor module 102/pulsate module 112.

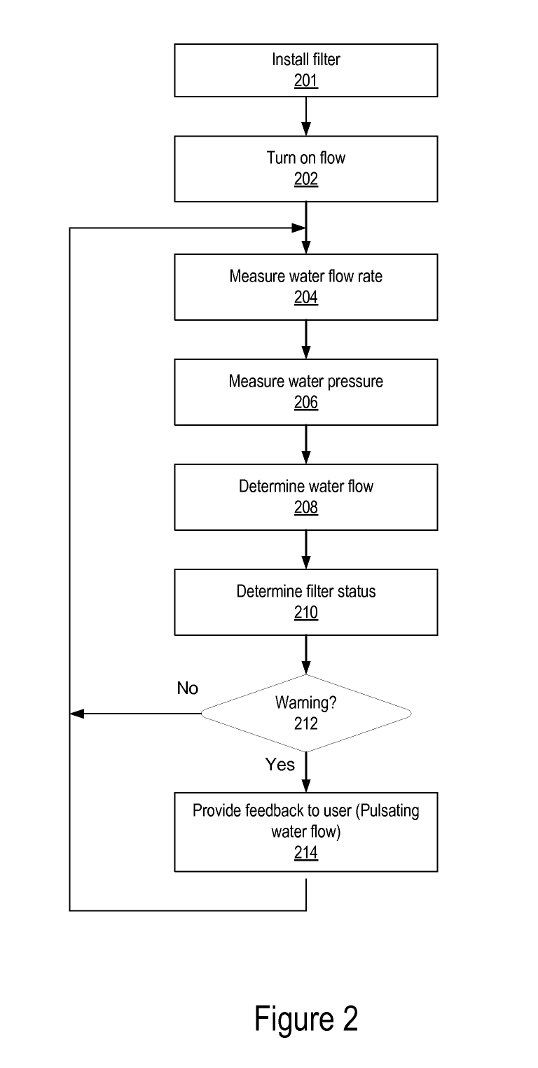

FIG. 2 is flowchart of the operation of one embodiment of the present invention. In this embodiment, a water filter is installed 201. The water filter can be a centralized water filter that filters the water entering the building or can be a plurality of water filters that filters water going to one or more faucets or other outputs in the buildings plumbing system. For ease of discussion, the description with respect to FIG. 2 will presume a centralized water filter. When a faucet or other output is turned on 202, the filter module 110 measures 204 the water flow rate and duration of the water flow, this can measure the water flow rate directly in the filter assembly or indirectly via a pipe through which water passes before or after proceeding through the filter. For ease of discussion “measures” in various embodiments can mean direct measurement (e.g., mechanical or other direct methods) or determining in another manner, such as measuring dynamic or differential pressure, for example. The filter module 110 can also measure 206 the water pressure. Based upon the water flow rate and/or the water pressure and the duration of the water flow the filter module 110 determines 210 the filter status. As described in more detail below, the filter status can be determined to be in a warning state (needing replacement or close to needing replacement) based upon set parameters that can be stored in the filter module 110 or in memory 104. If the filter module 110 determines 212 that no warning is necessary the process continues. In FIG. 2, the process continues by continuing to measure 204 the water flow rate. In other embodiments, the process can continue with step 201, 202, 206 or 208, for example. If the filter module 110 determines 212 that the filter is in a warning state, e.g., the filter has filtered its rated amount of water, then the filter module 110 instructs the pulsate module 112 to provide feedback to the user. In an embodiment, the water monitor module 102 wirelessly connects to the pulsate module 112 and instructs the pulsator 114 to cause one or more faucets to pulsate water when the faucet is turned on to provide an obvious signal to the user that the filter needs replacing. As described herein, the pulsate module 112 can include a processor 118 communication unit 116 and a pulsator 114, however in alternate embodiments the pulsate module can receive a signal from the water monitor module 102 and activate a solenoid or other device that mechanically causes the water to pulsate.

In one embodiment of the invention the system and method, the system (1) is programmed (and stored in the filter module 110 or memory 104) with the rated service life of one or more filter elements and/or water treatment system elements and/or the main system has the ability to sense the rated life of the system elements that are installed into it (2) detects (by the filter module 110) the amount of use a filter element or other water treatment system elements has undergone and/or determines the amount of remaining useful life a filter element or system element has and, based on this determination, (3) indicates to the user in real time the remaining filter element and/or system element life and the urgency at which the filter element or system element needs to be changed, and (4) provides a feedback loop to the water treatment system to possibly prevent further use of the system once the filter element and/or system element life limit has been reached, the can be achieved by having the water monitor module 102 turn off a valve.

The method and system incorporates some or all of the following elements: preprogrammed service life of the systems life time dependent elements, mechanism to code the service life of a system element into the replaceable system element, ability for a person to input the service life at an installed system element via an input/output device at the water monitor module 102 or via a separate user interface connected to the network 120, for example, a mechanism to store the rated service life of one or more system elements such as the filter module 110, a detection mechanism to detect the coded service life of a filter or system element, a mechanism to measure flow rate, a mechanism to maintain a running count of flow volume per user interaction and total since last servicing of a filter or other system element, a mechanism to measure and record the time the water is flowing through the system, a mechanism to maintain a running total of the time the system has been run since some known system event, a mechanism to indicate filter or other system element service life to the user, and a fail-safe/prevention of use mechanism that would stop system use if one or more of the system elements was beyond its service life.

In an embodiment, examples of mechanisms to program system elements with their respective rated service life are RFID tags, bar codes, plug-in circuitry to pass the data, wireless communication, color coding, physical features that can communicate data, and other machine readable codes, all of which the system could read and/or interpret to gain the information from the system element. Alternatively the information can be received by the filter module via a communication link 107 via, for example, a remote computer (not shown) that is coupled to the network.

Because filter or other system element life is typically measured/rated in gallons and filter performance ratings are tested and correlated to specific flow rate thresholds according to national and international standards for the performance and safety, various embodiments described herein include in its detection element, e.g., filter module 110, the ability to measure both flow rate (e.g., gallons per minutes, liters per minute) and flow volume (e.g., gallons, liters).

Detection of Filter or Other System Element Use with Respect to Rate Service Life

As described above, the detection function referenced above, can include a flow switch, a flow sensor, or flow meter and a microprocessor or similar logic device to achieve the measurements, e.g., in the water monitor module 102. The flow switch and flow sensor can be the same element, although in alternate embodiments they are separate elements. In an embodiment referenced here is to be referred to as a “variable flow rate” detection method and can include the steps of: (a) detecting flow with a flow switch when the system is activated by the user (e.g., water is flowing), and turning on the water treatment system, (b) detecting the presence of flow by the flow sensor and signaling the microprocessor, which includes a clock function that records the duration of flow, (c) detecting and signaling volume of flow by the flow meter to the microprocessor, and (d) determining, by the microprocessor, the flow rate based on comparison of volume of flow and duration of flow data/recordings, for example.

In one embodiment the microprocessor (or microcontroller) determines a volume of flow that has passed through the system. In some instances, the overall mechanical design of a POU or POE filtration or water treatment system may limit the actual flow rate through the system such that this flow rate never surpasses a rated maximum flow rate for the performance of replaceable filter or other system elements. In such cases, the flow rate through the system remains fairly constant (and below the maximum allowable threshold), so there is no need to detect/measure/indicate flow rate with respect to the risk that it can exceed a the maximum allowable. This method is deemed a “constant flow rate” detection method.

In addition to detecting the amount of use of a filter or other system element, in an embodiment of the present invention a factor in determining the service life of the filter is the length of time the filter or other system element has been in service, or present in the system regardless of the amount of flow through the system. The microprocessor, e.g., processor 108 in conjunction with a program stored in memory 104, can be used to determine the length of time various elements of the system have been installed and alert the user to the need for replacement for reasons other than volume of water processed, that effect system performance.

In an embodiment, the system would have the ability to sensor the current performance level and/or condition of a filter or other system element. Examples of such condition sensing would include sensing filter sediment clogging condition by sensing pressures in various areas of the system and calculating pressure drop across the filter element and comparing it to a value of a new filter. This new filter pressure drop value could be coded into the filter element, entered by a user or service person (for different filters), downloaded by the system from a network, or hardcoded into the system at the time of manufacture. An additional example of system element sensing is monitoring flow rates in various parts of the system and using them in conjunction with known system parameters, to calculate the pressure drop across a filter or other system element. With this real time information, the system can provide feedback to the user of not just filter or other system elements that have exceeded their rated service life, but also provide feedback to the user about the actual current operating condition of system in real time. This provides the added benefit of giving the user correct system performance feedback in situations where the environment and variables that were used to establish the rated service life of a filter or other system element are not the exact environment that the system has been used in. In an embodiment, these additional sensors are located in one or more water monitor modules 102. The real-time information or historical information can be sent to the user via a remote computer coupled to the network 120, or can be an SMS message, email, instant message, etc., using conventional techniques based on software in memory 104, for example, and communicating via network 120.

In an embodiment, the system has sensors to monitor levels or one or more consumables (e.g., salt in a system that has the function to soften water). The system may also have sensors that monitor the condition of system elements such as a sacrificial zinc electrode.

When the system is activated by the user, a switch detects flow and turns the filtration system on. This switch can be a pressure switch, a flow switch or some other mechanical on/off switch, like a solenoid valve.

The flow sensor detects the presence of flow and signals a microprocessor, in which a clock function in the microprocessor activates and records the duration of flow.

The flow rate through system is a known constant and is programmed into the microprocessor. In alternate embodiments a flow meter can be used to measure flow rate in variable flow rate systems.

Since duration of flow is measured and flow rate is known, e.g., constant, the microprocessor can then derive a volume of flow from these two data points (clock/duration data and flow rate). The microprocessor, e.g., processor 108, then determines volume of flow that has passed through the system.

User Indicator of Filter and Other System Element Life

Another element of an embodiment of this invention is the indicator system. In an embodiment this is a machine/user interface that provides feedback to the user regarding the status of filter and other system element life and when use maintenance action is needed, but in some instances may signal other performance measures such as flow rate.

The microprocessor uses system data acquired by the detection system described herein to signal the filter and other system element life and other performance feedback to the indicator system.

The user indicator system receives a signal from the microprocessor. The signal triggers a user feedback action/indicator in the indicator system. A goal of the user interface system is to notify the user that the user should take an action (e.g., changing the filter). There are many types of situations that trigger the indicator system. One example that can trigger the indicator system in the case of a filter element: (1) the used/remaining filter element life and (2) the urgency of the need to change the filter, based on how near the measured flow volume through the filter is to the filter capacity rating. The indicator system would then adjust its signal to the user to reflect increasing urgency to replace the filter.

In one embodiment, the indicator system signals the user when the filter element should be changed by changing the flow of the water delivered to the user. For example, a vibrating or pulsating stream of water when the faucet is turned on and the system determines that the end of the filter life is near, for example, via the pulsator 114 in pulsate module 112. In one embodiment, the pulses of water may get faster or slower as the ultimate time to change a filter element approaches, in alternate embodiments other variations to the water pulses may be used. The pulsating can mechanism can reside at each fixture location or can be centrally located in a larger system, with one or more filters. The pulsating can be accomplished by either impeding the flow of water or increasing the flow of water periodically, or both. Examples of mechanisms that could be used to create and/or control the pulsations include a solenoid valve, an electronically controlled pump, a valve controlled by a servo motor, piezo electric action, a pneumatic valve, a cam controlled or actuated pump, and a variable speed paddle wheel that can be electronically controlled.

Another embodiment for indicating filter life is the use a small visual display, e.g. a liquid crystal display (LCD) or any other visual display, in order to show that the filter or other system element needs to be attention. A plurality of visual interfaces on this display could be employed including a graphical user interface that plots a use curve showing filter life as a function of time remaining, gallons remaining, etc. This display can be positioned near the filter or remotely, e.g., on a remote computer coupled to network 120, or on a central control panel (not shown).

Another embodiment for indicating filter life is the use of colored light emitting diodes (LEDs) on a fixed/graduated scale or background (similar to a traffic light), e.g., green LED on bottom (ok), yellow LED in middle (warning), and red LED on top (stop/take action to replace filter). Within this simple scale, the “degree” of urgency in the warning phase could be depicted by varying the intensity of the yellow LED light, e.g., dim equals low urgency, bright equals high urgency or by using multiple yellow LEDs, in which each successively lit yellow LED indicates a higher level of urgency that filter life is near capacity. Other color schemes can also be used. Another example would be the use of just one LED indicator light location that has the ability to display a large variety of colors (e.g., an RGB LED).

Another indicator embodiment is to light the delivered water stream itself to indicate that the filter or other system element needs to be changed, or needs attention. LEDs and/or fiber-optic light pipes can be used to light up the delivered water stream as it is presented to the user. The water stream can be colorless at the start, and as the time approaches for the filter or other system element to be changed or serviced, the stream can turn more red (or any other color). These LEDs can also be powered by the water stream itself as the kinetic energy of the water is harvested and turned into electrical energy to power the LEDs.

Still another indication embodiment can be an audible alarm, computer generated sounds, computer generated voice, or recording that is played by the system when the system is activated and there are areas of the system that need attention (e.g., filter needs replacement). This can be part of an input/output unit in the water monitor module 102. For instance, an alarm can begin with a beep or tone when the filter element has reached a specified percentage of its useful life. As the system determines the filter element is approaching its maximum service rating, the frequency of the beep or tone can be increased to the point that when the filter has reached its maximum, the beep or tone is constant when the system is activated and water is flowing. In the same way, simple pre-recorded messages that are stored in and played back by a small speaker in the system can be used as audible warning indicators. For example in the case of a filter element, the first recorded message could indicate that 90% of filter element capacity has been reached, the second message could indicate that 95% of rated life has been used, and so on until the maximum filter element life has been reached and a recorded message alerts that the filter must be replaced because it is no longer safe to use.

### Fail-Safe Mechanism

Another aspect of the invention is a fail-safe/prevention of use mechanism that prevents a user from activating the system (e.g., starting the flow of water) if the system detects and/or computes that a filter or other system element has reached the end of its rated service life or and has not been replaced, or in the case of a consumable, replenished. A feature of this system including the fail-safe is also a detection mechanism that can determine if a filter or other system element has been replaced or replenished.

In one embodiment of this detection feature, a simple switch (mechanical, electrical, magnetic, etc.) is established between the replaceable element and the system. When the element is in place this switch is closed and the system's detection method described above functions normally. When this switch is opened, e.g., when the element is removed, a signal is received by the microprocessor indicating that the element has been removed. When a new element is inserted, the switch is again closed and the system is reset. This detection sequence is deemed an automatic reset.

With this embodiment, there exists the possibility that the user could get around the system's intended operation model by simply re-inserting the spent filter to fool the system into thinking a new element was inserted. One way to ensure that this is not possible is to make the switch contact on the replaceable filter a “one-way” or frangible mechanism that is destroyed when the element is removed. Examples of such frangible elements are a metal contact on the element that breaks off when the filter is extracted, or a wire that is severed, thus ensuring that the switch cannot be closed if the same spent element is re-inserted into the system. Another embodiment of an automated reset and to ensure that it is not possible to fool the system by reinserting a spent element is to incorporate a unique, radio frequency identification (RFID) tag on each replacement system element. Each RFID tag is unique. With this embodiment, the system's detection intelligence can recognize discrete RFIDs on replacement elements and the intelligence can be established such that a recognized RFID can be used for only a given capacity or rated service life, and once that capacity has been reached the system cannot be reactivated until a new, unique RFID tag is detected by the system. In another embodiment, the user can manually activate a reset “button” after an element has been replaced. This could be a simple mechanical, electrical or magnetic switch. This embodiment is deemed a manual reset.

There are a variety of ways to incorporate a fail-safe mechanism and to reactivate the system after a valid system reset has been established. One embodiment of a fail-safe is an automated valve, such as a solenoid, that can be triggered by the microprocessor. If the system detects that filter or other system element capacity or rated service life has been exceeded and no replacement or replenishment action has been taken, a solenoid valve somewhere in the system, e.g., between the faucet and the system inlet or between the system outlet and the dispensing lumen of the faucet, can be automatically triggered to shut off flow such that no water can enter the system or be dispensed by the system. This fail-safe ensures that water does not flow through the system when one or more of its elements are past their rated service life or needs replenishment. For example, a filter element used past its rated service life and that water flow is only restored when a spent filter element has been replaced with a new filter element. Alternatively, the system can have a bypass whereby water continues to flow to the user, but does not pass through the entire system and/or one of more elements of the system.

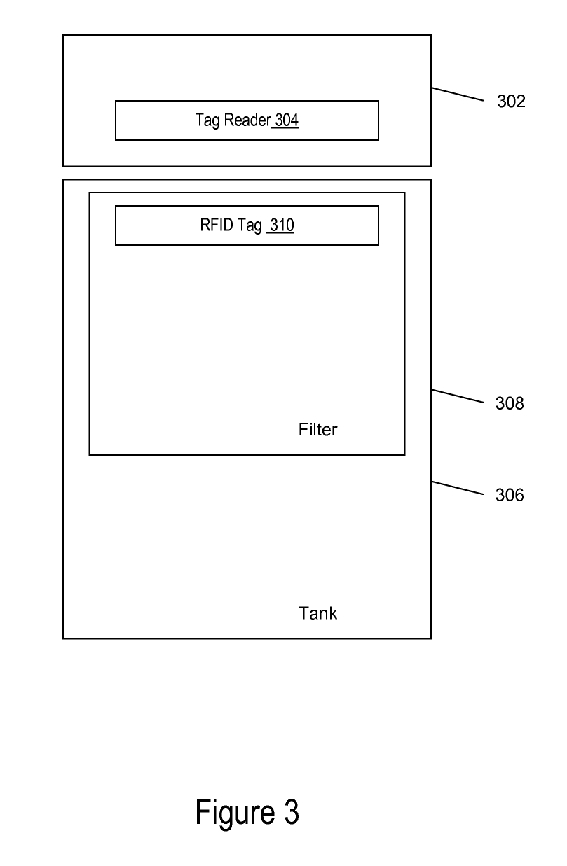

FIG. 3 is more detailed description of a water filter assembly in accordance with one embodiment of the present invention. FIG. 3 shows an embodiment of one method to construct part of the system, in this case a filter element and an embedded RFID tag and reader configuration for sensing the rated service life of the filter element. 302 is the removable top cap assembly of the water treatment system. It is removable to access the replaceable filter element inside the system. 304 is an antenna or RFID tag reader sub-assembly. It is built into the top cap assembly 302 and its physical location is known and substantially constant with respect to the filter element when installed in the system. 306 is the tank or water reservoir of the system. Its function is to hold and/or transmit water through the system. There is a water tight, but user serviceable connection between the top cap 302 and the tank 306. 308 is the replaceable filter element of the system. 310 is an embedded RFID tag that uniquely identifies the filter, the filter's rated service life and/or other parameters that can be based on the system. The embedded RFID tag 310 is in a known and repeatable position with respect the RFID tag reader 304 to insure the two components, when assembled and in use, are close enough to allow them to communicate as designed. When a user opens the top cap assembly 302 and removes in from the tank 306, they can access the filter element 308 for replacement. When a new filter element is then installed 308, and the top cap assembly is re-installed. The RFID reader 304 and the RFID tag 310 are automatically placed in the proper position with respect to one another for sensing and/or communication of the filter elements parameters by the system.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A computer based method for generating a pulsating water flow through a faucet in response to a filter status, comprising the steps of:
determining a filtered volume of water filtered by said first filter;
determining the filter status by comparing said filtered volume of water and an expected first filter life representing a rated service life value of said first filter; and
causing the faucet to expel pulsating water when the faucet is in the on state and when the filter status represents that remaining filter life is below a first threshold.

2. The method of claim 1, wherein said pulsating water has been filtered by said first filter.

3. The method of claim 1, further comprising the steps of:
determining the water pressure drop across the water filter;
determining the filter status further comprises comparing said water pressure drop with an expected water pressure drop across said first filter; and
causing the faucet to expel pulsating water when the filter status represents that the pressure drop across the first filter exceeds said expected water pressure drop by a second threshold value.

4. The method of claim 1, wherein said step of determining a filter volume of water comprises:
determining a water flow rate through a first filter, said first filter filters water before the water exits the faucet; and
determining a duration of water flow at said water flow rate;
wherein said filtered volume is determined based upon said water flow rate and duration of water flow.

5. The method of claim 4, further comprising the step of:
turning off the flow of water to the faucet when said first status exceeds a second threshold, wherein said second threshold is at or above the rated service life value of said first filter.

6. The method of claim 1, further comprising the step of:
turning off the flow of water to the faucet when said first status exceeds a second threshold, wherein said second threshold is at or above the rated service life value of said first filter.

7. The method of claim 1, wherein step of causing the faucet to expel pulsating water comprises at least one of impeding the flow of water and/or increasing the flow of water periodically.

8. The method of claim 7, wherein the pulsating can be done using at least one of a solenoid valve, an electronically controlled pump, a valve controlled by a servo motor, piezo electric action, a pneumatic valve, a cam controlled pump, an actuated pump, and/or a variable speed paddle.

9. The method of claim 1, wherein said first filter filters water for multiple faucets.

10. A computer based method for generating a pulsating water flow through a faucet in response to a filter status, comprising the steps of:
determining the filter status by at least one of comparing a filtered volume of water and an expected first filter life representing a rated service life value of a first filter and/or comparing a first time representing a time from which said first filter was installed and/or comparing a water pressure drop across said first filter with an expected water pressure drop across said first filter; and
causing the faucet to expel pulsating water when the faucet is in the on state and when the filter status represents that remaining filter life is below a first threshold.

11. The method of claim 10, further comprising the step of:
turning off the flow of water to the faucet when said first status exceeds a second threshold, wherein said second threshold is at or above the rated service life value of said first filter.

12. The method of claim 10, wherein step of causing the faucet to expel pulsating water comprises at least one of impeding the flow of water and/or increasing the flow of water periodically.

13. The method of claim 12, wherein the pulsating can be done using at least one of a solenoid valve, an electronically controlled pump, a valve controlled by a servo motor, piezo electric action, a pneumatic valve, a cam controlled pump, an actuated pump, and/or a variable speed paddle.

14. The method of claim 10, wherein said first filter filters water for multiple faucets.

15. A system for generating a pulsating water flow through a faucet in response to a filter status, comprising:
a first filter, to filter water;
the faucet, coupled to said first filter, said filtered water flowing to the faucet;
a water monitor module, for electronically communicating with said first filter and said faucet, to determine the filter status by at least one of comparing a filtered volume of water using a flow sensor and an expected first filter life representing a rated service life value of a first filter and/or comparing a first time representing a time from which said first filter was installed and/or comparing a water pressure drop across said first filter with an expected water pressure drop across said first filter using a pressure monitor; wherein said water monitor module transmits a control signal to cause the faucet to expel pulsating water when the faucet is in the on state and when the filter status represents that remaining filter life is below a first threshold.

16. The system of claim 15, further comprising:
a first valve, positioned upstream of the faucet, in response to a signal from said water monitor module, turning off the flow of water to the faucet when said first status exceeds a second threshold, wherein said second threshold is at or above the rated service life value of said first filter.

17. The system of claim 15, wherein a pulsator causing the faucet to expel pulsating water by at least one of impeding the flow of water and/or increasing the flow of water periodically.

18. The system of claim 17, wherein the pulsator can be at least one of a solenoid valve, an electronically controlled pump, a valve controlled by a servo motor, piezo electric action, a pneumatic valve, a cam controlled pump, an actuated pump, and/or a variable speed paddle.

19. The system of claim 15, wherein said first filter filters water for multiple faucets.
